(19) United States
(12) Patent Application Publication
(10) Pub. No.: US 2024/0140366 A1
(43) Pub. Date: May 2, 2024

(54) DEVICE FOR CLEANING A GLASS SURFACE

(71) Applicant: VALEO SYSTEMES D'ESSUYAGE, La Verriere (FR)

(72) Inventors: Frederic GIRAUD, La Verriere (FR); Alexandre FILLOUX, La Verriere (FR)

(73) Assignee: VALEO SYSTEMES D'ESSUYAGE, La Verriere (FR)

(21) Appl. No.: 18/548,675

(22) PCT Filed: Mar. 1, 2022
(86) PCT No.: PCT/EP2022/055181

§ 371 Date: Sep. 1, 2023

(30) Foreign Application Priority Data
Mar. 1, 2021 (FR) FR2101942

(51) Int. Cl. B60S 1/48; B60S 1/52

(52) U.S. Cl. CPC B60S 1/488; B60S 1/481; B60S 1/52

(57) ABSTRACT

A device for cleaning at least one glass surface of a vehicle, including at least one nozzle configured to spray a cleaning fluid onto the at least one glass surface, at least one line for dispensing the cleaning fluid, a pump, a plurality of solenoid valves or sets of solenoid valves, each solenoid valve being connected to one of the nozzles and coupled to at least one heating element.

### TECHNICAL FIELD

The present invention relates to a cleaning device with which motor vehicles are fitted. It relates more particularly to the field of systems for cleaning a glazed surface of such vehicles.

### BACKGROUND OF THE INVENTION

Regardless of the configuration of a motor vehicle glazed surface, it is necessary, for issues of occupant comfort but especially for issues of driving safety, that the glazed surface is cleaned correctly and that it is not covered by dirt which could hinder the ability to see through it. By way of examples, it will be appreciated that the windshield or the rear window of the vehicle need to be cleaned effectively to allow the vehicle occupants to readily discern events that are liable to occur in the roadway setting in which the vehicle is driving, and it will be appreciated that sensors forming part of a driving assistance device, regardless of the degree of autonomy of the vehicle on which this driving assistance device is integrated, again need to be cleaned effectively so that the acquired information is reliable and the driving assistance is effective and safe.

Various types of cleaning device are known, from among which it is notably possible to identify, without this being exhaustive, devices comprising motorized mechanical means for sliding along the glazed surface and removing dirt or means for projecting a cleaning fluid, this consisting of air or cleaning liquid.

Cleaning devices that project cleaning fluid notably comprise one or more nozzles, fixed or mobile, which are configured to project a cleaning fluid against a motor vehicle glazed surface next to which they are disposed. To supply the nozzles with cleaning fluid, such a cleaning device comprises at least one pump connected to each of the nozzles by an electrovalve ensuring the passage of the fluid or the blocking of its circulation within the cleaning device.

Cleaning devices such as those that have just been described allow glazed surfaces to be effectively cleaned of the vast majority of dirt, but they may nevertheless not be sufficient to remove, in a single cleaning operation, certain dirt that clings to the glazed surface for example after having dried, or certain organic debris such as insects. It is therefore necessary to provide for several cleaning operations until the glazed surface is perfectly transparent, and this may increase the treatment time and the cost spent on cleaning liquid.

Thus, the aim of the present invention is to overcome the aforementioned drawback and to propose a cleaning device with which a vehicle is fitted and which makes it possible to effectively get rid of solid debris contaminating the glazed surfaces or optical surfaces of the vehicle. The invention notably proposes a cleaning device comprising at least one heating element for heating the cleaning fluid and thus increasing the effectiveness of the cleaning. There is thus an increase in the effectiveness of the optical detection systems associated with the optical surfaces and/or better visibility for the use of the vehicle.

More particularly, the invention relates to a device for cleaning at least one glazed surface of a vehicle, comprising at least one nozzle configured to project a cleaning fluid onto the at least one glazed surface, said cleaning device comprising at least one line for distributing said cleaning fluid, a pump, a plurality of electrovalves or of sets of electrovalves, each electrovalve being respectively arranged on the distribution line between the pump and the at least one nozzle, the distribution line comprising a fluidic inlet in which the pump is disposed and at least one fluidic outlet in which the at least one nozzle is disposed, the cleaning device being characterized in that it comprises at least one element for heating the cleaning fluid, the heating element being coupled to one of the electrovalves or one of the sets of electrovalves.

Glazed surface is understood to mean a transparent surface that may be, for the one part, one of the glazings in the passenger compartment of the vehicle and notably a windshield or a rear window, or, for the other part, a glazed surface of a detection system with which the vehicle is fitted, and for example an optical surface of an optical sensor.

Glazed surface is also understood to mean any type of optical surface allowing the passage of signals from the detection systems. The glazed surface may thus be made of glass, plastics material or any type of materials known to those skilled in the art that allow the passage of signals from the detection systems.

The nozzle is then configured to project the cleaning fluid against the glazed surface, notably under the action of the electrovalve. Specifically, the function of the electrovalve is to at least partially control the circulation of the cleaning fluid in the distribution line, notably by enabling or blocking the passage of said cleaning fluid in said distribution line in the direction of the nozzle associated with the electrovalve.

### SUMMARY OF THE INVENTION

According to the invention, as has just been outlined, the heating element is coupled to an electrovalve or a set of electrovalves. It should be appreciated that the heating element is coupled in this case in that it is connected hydraulically to this electrovalve or set of electrovalves, the cleaning fluid passing through the heating element necessarily passing through the electrovalve or the set of electrovalves to which the heating element is coupled. The coupling between the heating element and the electrovalve or set of electrovalves can be described as a direct coupling, in that no component of the cleaning device is interposed between the heating element and the electrovalve.

The function of the heating element is to heat the cleaning fluid circulating in the distribution line in the direction of the nozzle. More precisely, the heating element is coupled to the electrovalve or the set of electrovalves such that the cleaning fluid which is projected by the nozzle or nozzles associated with said electrovalve or with the set of electrovalves is a heated cleaning fluid that is more effective in terms of its function of cleaning the glazed surface of the motor vehicle.

According to one feature of the invention, a plurality of electrovalves or sets of electrovalves are successively connected to the distribution line via hydraulic connection members, the at least one heating element being disposed between two hydraulic connection members.

The hydraulic connection member enables the passage of the cleaning fluid from the distribution line to the electrovalve. It will then be appreciated that with such a disposition of the heating element, the latter heats the cleaning fluid circulating in the distribution line downstream of the heating element. Thus, the nozzles which are connected to the electrovalves associated with a hydraulic connection member disposed downstream of the heating element are intended to spray the cleaning fluid heated by said heating element, whereas the nozzles which are connected to the electrovalves associated with a hydraulic connection member disposed upstream of the heating element are intended to spray the non-heated cleaning fluid, which is substantially at the same temperature as that of the fluid present in the pump. It will be appreciated that the notion of upstream and downstream for a hydraulic connection member with respect to the heating element is linked to the order in which the cleaning fluid passes through the heating element and this hydraulic connection member. A hydraulic connection member is thus downstream of the heating element if the cleaning fluid first passes through the heating element then through the hydraulic connection member.

It may notably be chosen to provide heating elements only at precise positions of the distribution line, in order to target the electrovalves and the associated nozzles in which it is useful to have heated cleaning liquid. By way of example, since the heated cleaning liquid is notably useful for removing solid debris from the glazed surface, such as squashed insects, and since insects are liable to be present on the frontally disposed optical surfaces but not on the laterally disposed optical surfaces, heating elements may be provided directly upstream of the hydraulic connection members associated with the front nozzles.

According to one feature of the invention, the distribution line comprises a plurality of heating elements distributed along the distribution line, each heating element being disposed between two hydraulic connection members of the electrovalves.

The plurality of heating elements distributed on the distribution line, between two fluidic connection members, that is to say along the distribution line designed as a hydraulic bus successively distributing to each electrovalve or set of electrovalves, are taken advantage of in that they make it possible to ensure that the cleaning liquid is sufficiently heated at that end of the distribution line which is opposite the pump if it is deemed necessary that the electrovalves or sets of electrovalves disposed at the end of the distribution line need to receive heated cleaning liquid.

According to one feature of the invention, the distribution line comprises at least one main branch and at least one additional branch which is specific to one of the electrovalves or to one of the sets of electrovalves and which is connected to said at least one main branch by an interconnection point, and wherein a heating element is coupled to the electrovalve or to the set of electrovalves which is disposed on the at least one additional branch.

It will be appreciated that with such a configuration of the distribution line, the coupling of the heating element with the electrovalve or the set of electrovalves which is disposed on the additional branch makes it possible to heat the cleaning fluid circulating solely in said additional branch. It is thus possible to obtain precise heating of the cleaning fluid passing through certain electrovalves without this heating by the heating element having an impact on the rest of the distribution line. It will also be appreciated that the distribution line may comprise a plurality of additional branches, each being connected to the main line by a separate interconnection point.

According to one feature of the invention, the distribution line comprises a plurality of additional branches connected to the main branch of the distribution line by a single interconnection point.

Such a configuration is taken advantage of in that it makes it possible to distribute the cleaning fluid homogeneously into each of the additional branches, the latter having one and the same interconnection point with the main branch.

According to one feature of the invention, the set of electrovalves is disposed on the at least one additional branch of the distribution line, the heating element being disposed between the interconnection point and the set of electrovalves.

It will be appreciated from such a disposition of the heating element that the latter is able to heat the cleaning fluid intended to pass through each of the electrovalves of the set of electrovalves which is positioned on the additional branch.

According to one alternative of the invention, the set of electrovalves is disposed on the at least one additional branch of the distribution line, the heating element being disposed between the set of electrovalves and one of the nozzles associated with this set of electrovalves.

It will be appreciated that with such a disposition of the heating element, the latter is able to heat the cleaning fluid intended to be sprayed by one of the nozzles connected to one of the electrovalves of the set of electrovalves. Precise heating of the cleaning fluid intended for one of the nozzles of the cleaning device is thus enabled without having an impact on the cleaning fluid intended to be sprayed by other nozzles of the cleaning device.

According to another alternative of the invention, the heating element is integrated into the at least one electrovalve. The term integrated is understood to mean that the electrovalve and the heating element are housed in one and the same housing and have, where appropriate, common electronic circuits.

According to one feature of the invention, the cleaning device comprises a module for controlling the heating element, said module being configured to generate a preheating instruction for the heating element as a function of a control instruction for the electrovalve or the set of electrovalves.

It will be appreciated that in this case it is sought to provide an immediate heating effect when the cleaning fluid passes through the heating element. By way of non-limiting example, the preheating may consist in activating the heating element a few moments prior to the instruction for opening the electrovalve or the associated set of electrovalves. Alternatively, a preheating instruction may be generated periodically, at regular intervals whose duration may for example depend on the external temperature, so as to ensure that the cleaning fluid is always at a temperature greater than a threshold temperature value, in order to be certain of the effectiveness of the cleaning fluid regardless of when the electrovalve is triggered.

According to one feature of the invention, the heating element may consist of a passive storage member liable to store energy and to release it to the passage of cleaning fluid, and for example a phase change material.

According to various features of the invention, the heating element may consist of an element with PTC (positive temperature coefficient) effect, or of a resistive element in the form of a wire or sleeve, the heating element being configured to be, depending on the forms it takes, disposed against a pipe for the passage of cleaning fluid or housed inside this pipe, or even in a cleaning fluid tank.

The invention furthermore relates to a motor vehicle comprising at least one glazed surface and at least one device for cleaning said at least one glazed surface as defined above, the cleaning device being able to spray the fluid against said at least one glazed surface.

### BRIEF DESCRIPTION OF DRAWINGS

Further features, details and advantages of the invention will become more clearly apparent from reading the description given below by way of indication with reference to the drawings in which:

FIG. 1 is a schematic view of a cleaning device integrated within a motor vehicle, the motor vehicle comprising at least one glazed surface and the cleaning device comprising at least one line for distributing a cleaning fluid;

FIG. 2 is a schematic view of at least one nozzle and of at least one electrovalve of the cleaning device in FIG. 1, the electrovalve being coupled to at least one heating element;

FIG. 3 is a schematic view of the cleaning device in FIG. 1 according to a first embodiment;

FIG. 4 is a schematic view of the cleaning device in FIG. 1 according to a second embodiment in which the line comprises at least a main branch and an additional branch coupled to the main branch by an interconnection point;

FIG. 5 is a schematic view of the cleaning device in FIG. 1 according to a third embodiment in which a plurality of additional branches are coupled to a main branch of the distribution line by a single interconnection point;

FIG. 6 is a schematic view of the cleaning device in FIG. 1 according to a fourth embodiment of the invention, showing a variant of the positioning of the heating element with respect to the third embodiment of the invention.

### DETAILED DESCRIPTION OF THE INVENTION

It should first of all be noted that, while the figures set out the invention in detail for the implementation thereof, these figures may of course be used to better define the invention, where appropriate. It should also be noted that these figures set out only exemplary embodiments of the invention. Lastly, the same references denote the same elements throughout the figures.

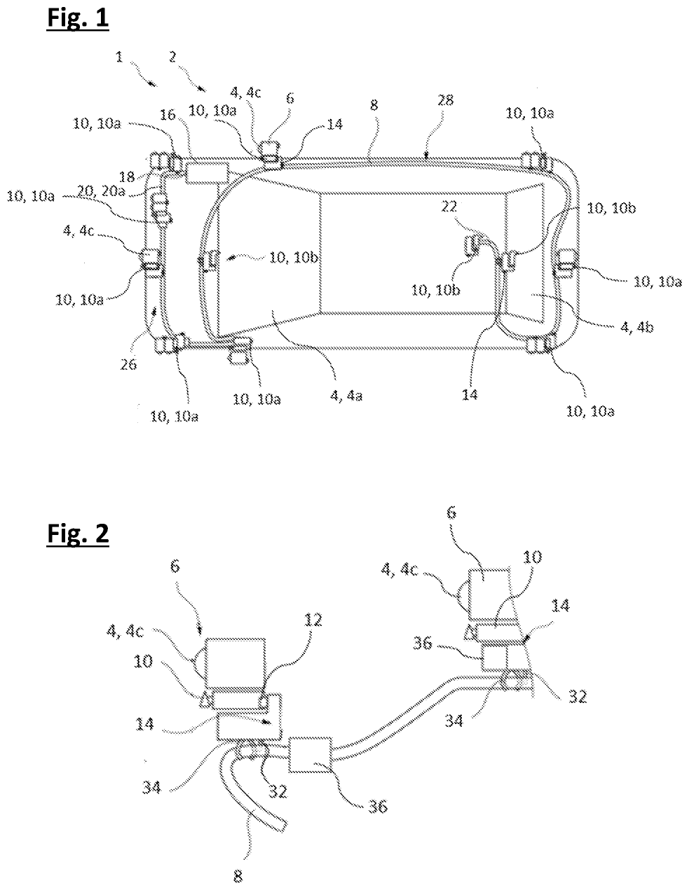

FIG. 1 schematically illustrates a motor vehicle 1 fitted with a cleaning device 2 according to the invention, allowing at least one glazed surface 4 of the vehicle 1 to be cleaned. Such a glazed surface 4 may be, for example, a windshield 4a or a rear window 4b of the vehicle 1, or it may be an optical surface 4c of an optical detection system 6 with which the vehicle 1 is fitted.

The cleaning device 2 comprises at least one line 8 for distributing a cleaning fluid that is able to circulate said cleaning fluid and devices for projecting the cleaning fluid that are disposed at least one fluidic outlet 12 of the distribution line 8 and that in this case take the form of nozzles 10. The nozzles 10 are then disposed in the vehicle 1 such that they are each associated with the cleaning of at least one of the glazed surfaces 4. Furthermore, the cleaning device 2 comprises a plurality of electrovalves 14 or a plurality of sets of electrovalves 14 disposed on the distribution line 8. Each electrovalve 14 is controlled so as to enable or block the passage of the cleaning fluid in a specific portion of the distribution line 8 in the direction of one or more nozzles corresponding to this electrovalve. The at least one nozzle 10 and the plurality of electrovalves 14 or sets of electrovalves 14 will be described in more detail below in the remainder of the detailed description.

Furthermore, the cleaning device 2 comprises a pump 16 and a cleaning fluid storage tank (not shown). The pump 16 is configured to recover the cleaning fluid from the storage tank and to supply the distribution line 8 continuously with cleaning fluid. More particularly, an outlet 18 of the pump 16 is connected to a first end 20 of the distribution line 8, forming a fluidic inlet 20a of the distribution line 8. This has the result that the distribution line 8 extends along the vehicle 1 from this first end 20 to a second end 22. In the illustrated example, the second end 22 of the distribution line 8, said second end being opposite the first end 20, is closed such that the cleaning fluid is liable to be distributed successively in the direction of each of the electrovalves disposed along the path from the first end 20 to the second end 22 of the distribution line 8.

Still referring to FIG. 1, first nozzles 10a are intended to clean the optical surfaces 4c of the optical detection systems 6 used for automatic analysis of the road setting, that is to say analysis by the electronics of the vehicle 1 in order notably to control a driving assistance and/or maneuvering assistance device of this vehicle, and second nozzles 10b are intended to clean a glazed surface 4 of the passenger compartment or an optical surface 4c of one of the optical detection systems 6 used only for direct analysis by the driver of the vehicle 1.

The distribution line 8 in this case has a first portion 26 arranged in the front part of the vehicle 1 and a second portion 28 arranged in the passenger compartment, each portion 26, 28 winding in the corresponding part of the vehicle in order to distribute to all of the nozzles 10 present in this part of the vehicle. It will be appreciated that hydraulic continuity is achieved in this case between these portions 26, 28, since a single pump 16 is provided on the distribution line 8.

Referring to FIG. 2, a more detailed description will now be given of the nozzles 10 of the cleaning device 2 and their cooperation with the electrovalves 14 and the distribution line 8 common to at least two of these nozzles 10, such as they have been shown schematically in this FIG. 2. Each nozzle 10 is fluidically associated with an electrovalve 14, in such a way that the cleaning fluid, as it circulates in the distribution line 8, initially passes through the electrovalve 14 then through the nozzle 10. Thus, when the electrovalve 14 is in an open configuration, it enables the passage of the cleaning fluid circulating in the distribution line 8 toward the nozzle 10 to which it is associated. The cleaning fluid is then projected by the nozzle 10 onto the optical surface 4c of the optical detection system 6 associated with the nozzle 10.

It should be considered that the cleaning device 2 may furthermore comprise sets of electrovalves 14 on its distribution line. Set of electrovalves 14 is then understood to mean at least two electrovalves 14 that are grouped together and that receive the cleaning fluid simultaneously, by being controlled simultaneously where appropriate. Sets of electrovalves are notably formed when a plurality of nozzles 10 are directed toward the same glazed surface 4 of the motor vehicle, or when a plurality of nozzles are directed toward adjacent glazed surfaces and/or glazed surfaces respectively associated with optical detection systems having the same detection function. Thus, in the remainder of the description, it will be appreciated that the features relating to one of the electrovalves 14 of the cleaning device 2 apply, mutatis mutandis, to a plurality of electrovalves 14 or sets of electrovalves 14.

The cleaning device 2 comprises at least one hydraulic connection member 32 for connection of the electrovalve 14 to the distribution line 8. The hydraulic connection member 32 has a form that is liable to ensure the passage of the cleaning fluid from said distribution line 8 toward the nozzle 10. In the schematically illustrated example, the hydraulic connection member 32 may have the tubular and slender form of a syringe, liable to pierce the distribution line 8 which furthermore forms a hydraulic bus able to distribute the cleaning fluid in the direction of each of the electrovalves. At the point of assembly of the hydraulic connection member 32 on the distribution line 8, a resin (not shown) may be used to surround an area of contact between the hydraulic connection member 32 and the distribution line 8, in order to ensure that this area of contact is airtight. It should be noted that the hydraulic connection member is in this case shown in the form of a tapping substantially perpendicular to the cleaning fluid circulation flow, but it could, without departing from the context of the invention, consist of a Y-shaped fitting, for example, so long as the fluid can flow continuously between the distribution line and a line able to direct the fluid toward the nozzle.

The cleaning device 2 also comprises at least one mechanical holding member 34 for fastening the electrovalve 14 and the nozzle 10 to the distribution line 8. In the illustrated example, the mechanical holding member 34 takes the form of a clamp at least partially surrounding the distribution line 8. Provision may for example be made of a holding member with elastic deformation, defining, in its starting position, a groove with dimensions substantially smaller than those of the distribution line 8, the operator then having to force the mechanical connection member 34 to deform so as to be able to engage on the distribution line 8, and the elastic return of the mechanical holding member 34 ensuring it is held in position on said line.

The cleaning device 2 comprises at least one element 36 for heating the cleaning fluid, the heating element 36 being coupled to at least one of the electrovalves 14 of the cleaning device 2. According to one example of the invention, the heating element 36 may take the form of a resistive element in contact with the pipe in which the cleaning fluid circulates, and the function of this heating element is to ensure the heating of the cleaning fluid intended to pass through the electrovalve to which the heating element is coupled, thus making it possible to increase the effectiveness of the cleaning by said cleaning fluid. Specifically, the hot cleaning fluid has a greater cleaning effectiveness than that of a cold cleaning fluid for ridding the glazed surface of debris, notably solid debris. In other words, the heating element 36 is coupled to the electrovalve 14 such that it ensures the heating of the cleaning fluid which is projected by the nozzle 10 connected to said electrovalve 14. The coupling of the heating element 36 to the electrovalve 14 is such that the hydraulic connection thus formed between the two components entails that the cleaning fluid necessarily passes through the electrovalve or the set of electrovalves after having passed through the heating element, or vice versa.

According to one exemplary embodiment illustrated in FIG. 2, in which two electrovalves 14 of the cleaning device 2 that are connected successively of one another to the distribution line 8 via the hydraulic connection members 32 mentioned above are visible, the at least one heating element 36 is disposed between the two hydraulic connection members 32 of the two electrovalves 14. It will then be appreciated that with such a configuration of the cleaning device 2, the function of the heating element 36 is to heat the cleaning fluid for the nozzles 10 which are positioned downstream of the heating element 36 according to the circulation of the cleaning fluid.

According to another example of the invention also visible in FIG. 2, the heating element 36 may be integrated directly within the electrovalve 14. The term integrated directly is understood to mean that the heating element 36 and the electrovalve 14 form a single element, in the same housing, and the electronic components thereof may be associated with one another. By way of example, this housing may comprise a control module which is able to issue a control instruction for the heating element and which is able to communicate with the electrovalve or the set of electrovalves in order to, where appropriate, synchronize the operation of the heating element and of the electrovalve or the set of electrovalves. The control module may notably generate a preheating instruction for the heating element as a function of a control instruction for the electrovalve or the set of electrovalves, so as to optimize the heating period in order to be effective while still limiting the overall electrical consumption of the device.

It should be noted that the two exemplary embodiments which have just been described have been shown in the same FIG. 2 to render visible several possible configurations of the heating elements, but the one or the other of the exemplary embodiments may be implemented on its own.

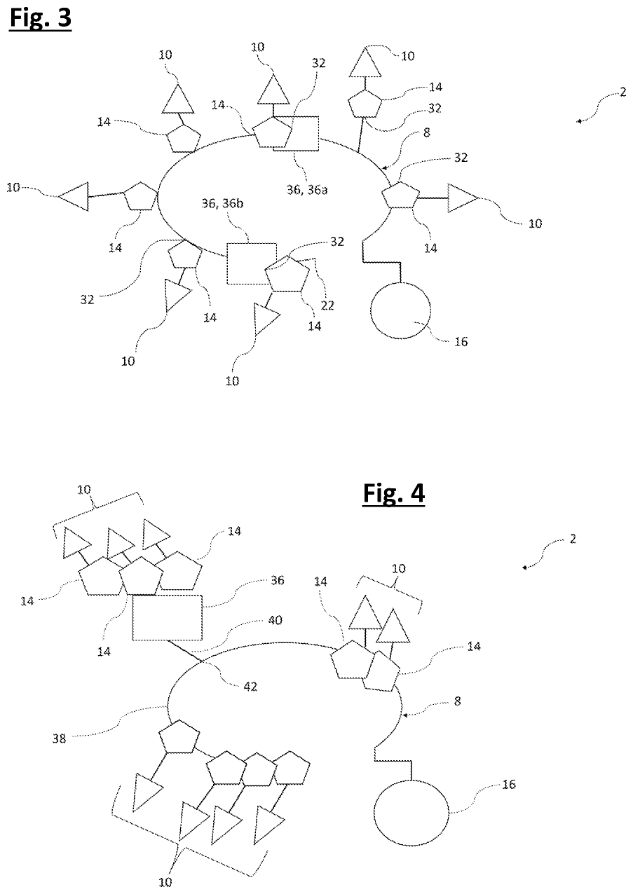

Several embodiments of the invention will now be described by means of FIGS. 3 to 6, each schematically illustrating one embodiment of the invention. It should then be considered that only the different features of each of the embodiments will be described in detail in the remainder of the description. For the common elements, reference should be made to FIGS. 1 and 2 described above.

FIG. 3 schematically illustrates the cleaning device 2 with a plurality of electrovalves 14 disposed successively one after the other along the distribution line 8 and connected hydraulically to this distribution line via a hydraulic connection member 32. The cleaning device also comprises a plurality of heating elements 36 distributed along the distribution line 8 and more particularly such that each of the heating elements 36 is disposed on the distribution line 8 between two successive hydraulic connection members 32. In the illustrated example, a first heating element 36a is positioned closer to the pump 16 than a second heating element 36b, the first heating element 36a being disposed between the second and third hydraulic connection members arranged along the distribution line, and the second heating element 36b being disposed between the two hydraulic connection members 32 that are closest to the second end 22 of the distribution line 8.

It will be appreciated that the cleaning fluid circulating in the distribution line 8 is heated as soon as it meets a heating element and that the nozzles 10 associated with the electrovalves 14 downstream of the heating element are thus supplied with heated cleaning fluid, in contrast to the nozzles 10 associated with the electrovalves 14 upstream of the heating element. In the illustrated example, the two nozzles 10 associated with the two first electrovalves on the distribution circuit, that is to say the two electrovalves disposed closest to the first end 20, are upstream of the first heating element 36a, such that the cleaning fluid circulating in these two nozzles is not heated, whereas the other nozzles, downstream of the first heating element 36a, are intended to receive heated cleaning fluid, if the first heating element 36a is controlled to operate and heat the fluid. In this context, it can be appreciated that the greater the distance away from the first heating element 36a approaching the second end 22 of the distribution line is, the lesser the extent to which the heat cleaning fluid has an elevated temperature. It is thus advantageous to provide the second heating element 36b, notably in the vicinity of the second end 22 of the distribution line 8, in order to reheat the cleaning fluid and restore it to the temperature that it had just after passing through the first heating element 36a.

FIG. 4 schematically illustrates the cleaning device 2 according to a second embodiment in which the distribution line 8 comprises at least one main branch, in this case for example a main branch 38, and at least one additional branch, in this case for example an additional branch 40. More precisely, the main branch 38 in this case contributes to forming a hydraulic distribution bus in accordance with what has been described with reference to FIG. 1, and the additional branch 40 is attached to the main branch 38 while being specific to at least one of the electrovalves 14 of the cleaning device 2, in this case one of the sets of electrovalves 14. In other words, the set of electrovalves 14 is fluidically connected to the additional branch 40 and the latter is connected to the main branch 38 by an interconnection point 42.

In this second embodiment, the heating element 36 is coupled to the set of electrovalves 14 which is disposed on the additional branch 40, the heating element itself being disposed on the additional branch. The particular disposition of the heating element 36 on the additional branch 40 makes it possible to heat only that part of the cleaning fluid which passes through the additional branch 40 of the distribution line 8. In other words, the heating action, and the expenditure of electrical energy necessary to carry out this heating action, is limited to a portion of the distribution line and a portion of the fluid circulating therein. The heating is for example targeted for nozzles associated with glazed surfaces that are disposed in the front part of the vehicle, and that are therefore liable to be covered by solid dirt such as squashed insects. More precisely, the heating element 36 is in this case disposed upstream of the set of electrovalves 14, that is to say between the interconnection point 42 and the set of electrovalves 14. Thus, the heating element 36 ensures the heating of the cleaning fluid prior to its passage through the set of electrovalves 14 positioned on the additional branch 40.

In this way, all the nozzles 10 which are positioned downstream of the electrovalves present on this additional branch are supplied with heated cleaning fluid.

It should be considered that the distribution line 8, such as it is described in this second embodiment of the invention, may comprise a plurality of additional branches that are each connected to the main branch by a separate interconnection point.

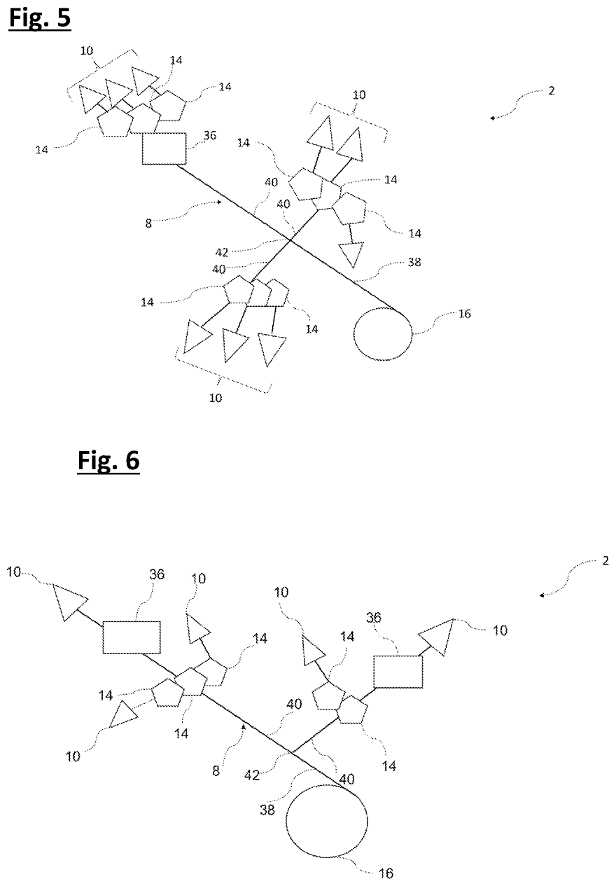

FIG. 5 schematically illustrates a third embodiment of the cleaning device 2 which is distinguished from the second embodiment described above by the fact that the distribution line 8 comprises a plurality of additional branches 40 connected to the main branch 38 of the distribution line 8 by a single interconnection point 42. In the illustrated example, the distribution line 8 comprises three additional branches 40 connected to the main branch 38 by the single interconnection point 42, each of the additional branches 40 being specific to one of the separate sets of electrovalves 14. The heating element 36 is then disposed between one of the sets of electrovalves 14 of one of the additional branches 40 of the distribution line 8 and the interconnection point 42.

In accordance with what has been described for the second embodiment, the position of the heating element 36 on the distribution line 8 makes it possible to heat only the cleaning fluid which passes through the additional branch 40 bearing the set of electrovalves 14 to which the heating element 36 is coupled. And the heating element 36 can heat the cleaning fluid which passes through all the electrovalves 14 of the set of electrovalves 14 of the additional branch 40 in question.

FIG. 6 illustrates a fourth embodiment of the invention, forming an alternative of the third embodiment, and in which the heating element 36 is this time positioned between the set of electrovalves 14 and the nozzle 10. More precisely, the heating element 36 is disposed between one of the electrovalves 14 of the set of electrovalves 14 and the nozzle 10 with which said electrovalve is associated. As above, the heating element is specifically associated with one additional branch but its disposition downstream of the set of electrovalves in this case makes it possible to heat the cleaning fluid which passes through only one of the electrovalves 14 of the set of electrovalves 14 borne by one of the additional branches 40 of the distribution line 8. Such an embodiment is taken advantage of in that it allows targeted heating of the cleaning fluid. In other words, the heating element 36 heats only the cleaning fluid intended to be sprayed onto one of the glazed surfaces by one of the nozzles 10 associated with one of the electrovalves 14 of the set of electrovalves 14 which is borne by one of the additional branches 40 of the distribution line 8. Again, the heating may notably be targeted for nozzles associated with glazed surfaces that are disposed in the front part of the vehicle, and that are therefore liable to be covered by solid dirt such as squashed insects.

The cleaning device such as has just been described is taken advantage of in that it allows, through simple means, better cleaning of the glazed surfaces comprised within a motor vehicle. Notably, the disposition of at least one heating element coupled to an electrovalve makes it possible to heat the cleaning fluid intended to be sprayed by one or more nozzles associated with this electrovalve, and this may notably have an advantage for carrying out specific heating of a portion of cleaning liquid intended to be projected onto one of the glazed surfaces, in order to limit the energy consumption to the strict minimum required for heating the liquid.

The invention as has just been described is not, however, limited to the means and configurations exclusively described and illustrated, but also applies to all equivalent means or configurations and to any combination of such means or configurations.

What is claimed is:

1. A device for cleaning at least one glazed surface of a vehicle, comprising at least one nozzle configured to project a cleaning fluid onto the at least one glazed surface, at least one line for distributing the cleaning fluid, a pump, a plurality of electrovalves or of sets of electrovalves, each electrovalve being respectively arranged on the distribution line between the pump and the at least one nozzle, the distribution line includes a fluidic inlet in which the pump is disposed and at least one fluidic outlet in which the at least one nozzle is disposed, and at least one element for heating the cleaning fluid, the heating element being coupled to one of the electrovalves or one of the sets of electrovalves.

2. The cleaning device as claimed in claim 1, wherein a plurality of electrovalves or sets of electrovalves are successively connected to the distribution line via hydraulic connection members, the at least one heating element being disposed between two hydraulic connection members.

3. The cleaning device as claimed in claim 2, wherein the distribution line comprises a plurality of heating elements distributed along the distribution line, each heating element being disposed between two hydraulic connection members of the electrovalves.

4. The cleaning device as claimed in claim 1, wherein the distribution line includes at least one main branch and at least one additional branch which is specific to one of the electrovalves or to one of the sets of electrovalves and which is connected to the at least one main branch by an interconnection point, and wherein a heating element is coupled to the electrovalve or to the set of electrovalves which is disposed on the at least one additional branch.

5. The cleaning device as claimed in claim 1, wherein the distribution line includes a plurality of additional branches connected to the main branch of the distribution line by a single interconnection point.

6. The cleaning device as claimed in claim 4, wherein the set of electrovalves is disposed on the at least one additional branch of the distribution line, the heating element being disposed between the interconnection point and the set of electrovalves.

7. The cleaning device as claimed in claim 4, wherein the set of electrovalves is disposed on the at least one additional branch of the distribution line, the heating element being disposed between the set of electrovalves and one of the nozzles associated with the set of electrovalves.

8. The cleaning device as claimed in claim 1, wherein the heating element is integrated into the at least one electrovalve.

9. The cleaning device as claimed in claim 1, further comprising a module for controlling the heating element, the module being configured to generate a preheating instruction for the heating element as a function of a control instruction for the electrovalve or the set of electrovalves.

10. A motor vehicle comprising at least one glazed surface and at least one device for cleaning the at least one glazed surface, the cleaning device including at least one nozzle configured to project a cleaning fluid onto the at least one glazed surface, at least one line for distributing the cleaning fluid, a pump, a plurality of electrovalves or of sets of electrovalves, each electrovalve being respectively arranged on the distribution line between the pump and the at least one nozzle, the distribution line includes a fluidic inlet in which the pump is disposed and at least one fluidic outlet in which the at least one nozzle is disposed, and at least one element for heating the cleaning fluid, the heating element being coupled to one of the electrovalves or one of the sets of electrovalves, with the cleaning device being able to spray the fluid against the at least one glazed surface.
